(19) United States
(12) Patent Application Publication
(10) Pub. No.: US 2003/0041235 A1
(43) Pub. Date: Feb. 27, 2003

(54) Configuration tool

(75) Inventor: Jurgen Meyer, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/196,423

(22) Filed: Jul. 17, 2002

(30) Foreign Application Priority Data
Aug. 21, 2001 (EP) 01 440 278.8

(51) Int. Cl. G06F 9/00

(52) U.S. Cl. 713/1

(57) ABSTRACT

The object of the invention is to provide an optimized development of a processor platform for an integrated circuit. The configuration tool according to the invention for automatic generation of at least one software file and/or at least one hardware file for a special processor platform for an integrated circuit, in particular an ASIC or a system-on-chip, where the processor platform has at least one processor and at least one module connected together via a bus, contains at least one selectable parameter for at least one processor and at least one module and generates the at least one software file and/or the at least one hardware file as a function of the selected parameters.

### TECHNICAL FIELD

The invention relates to a configuration tool.

The invention is based on a priority application EP 01 440 278.8 which is hereby incorporated by reference.

### BACKGROUND OF THE INVENTION

Integrated circuits are produced e.g. as system-on-chip on an ASIC; ASIC=application-specific integrated circuit. An ASIC contains special circuits adapted to customer requirements. These fulfil special tasks. In telecommunications they are used for example to process the VoIP signals, DSL, ATM, SDH, SONET, UMTS, GSM, LMDS or ISDN signals; VoIP=voice over Internet protocol, DSL=digital subscriber line, ATM=asynchronous transfer mode, SDH=synchronous digital hierarchy, SONET=synchronous optical network, UMTS=universal mobile telecommunication system, GSM=general system mobile, LMDS=local multipoint digital system, ISDN=integrated services digital network. They are therefore used for processing speech, data, video, internet web pages etc.

An integrated circuit has e.g. a special processor platform for the performance of general but also application-specific tasks. This processor platform can be used for any application; the same processor platform for example in DSL chips, ATM chips etc. It contains the processor and provides computer capacity.

The processor platform has several modules where some modules are connected to a fast AMBA-AHB bus e.g. a processor, a ROM controller, a RAM controller, and other modules are connected to a slow AMBA-APB bus e.g. an interrupt controller, a real time counter, ROM=read only memory, RAM=random access memory. The question of which module is connected to which bus depends on the access speed, processing speed and frequency of use of the module.

In the development of an ASIC the processor platform must always be developed fresh, adapted to the special requirements for the ASIC. This is time-consuming. In many integrated circuits e.g. FPGA with integrated processor platform, a processor type defined in advance with a particular processing speed is used, where a firmly prespecified configuration of a platform i.e. number and type of peripheral modules and size of the internal RAM and ROM are not selectable; FPGA=free programmable gate array. The FPGA can be expanded so that there is a certain degree of freedom, and adaptation to requirements for a particular application can be ensured subsequently. However the degree of freedom is restricted in that the processing speed cannot be changed by the choice of processor. In addition the preset configuration of the peripheral modules could be unsuitable or inadequate with regard to memory size, performance and interface.

Alternatively the processor platform can be optimized to the requirements of the ASIC. In each individual case however the processor platform must be developed new. This is firstly very time-consuming. Secondly each new development is highly susceptible to errors so that several attempts are required for test, removal of software and/or hardware errors etc.

### SUMMARY OF THE INVENTION

The object of the invention is to provide an optimized development of a processor platform for an integrated circuit.

The task is solved by a configuration tool for automatic generation of at least one software file and/or at least one hardware file for a special processor platform for an integrated circuit, in particular an ASIC or a system-on-chip, wherein the processor platform contains at least one processor and at least one module, which are connected together via a bus, wherein the tool contains at least one selectable parameter for at least one processor and at least one module, and wherein the at least one software file and/or at least one hardware file are generated as a function of the parameters selected. The software configuration tool opens up the possibility of generating a processor platform tailored to the application of the integrated circuit by entering the desired parameters e.g. number of processors, selection of processor type, selection of the requirement for memory controllers. By means e.g. of a GUI (graphical user interface), the configuration tool is given the relevant parameters for the development of a processor platform to fulfil the requirements imposed on a special ASIC. The configuration tool checks whether a sensible selection of parameters has been made i.e. a processor platform is possible under the peripheral conditions selected, and if the selection is sensible, generates VHDL files as a function of the parameters, module library files and template files. The generated VHDL files are used to establish the processor platform on the ASIC. In addition the configuration tool advantageously generates a software boot file and test files. By means of the boot file the processor on the generated processor platform is booted. By means of the test files the basic functions of the processor platform are checked. Both boot and test are performed automatically so that the processor platform can be used directly in order e.g. to perform ASIC-specific processing.

The module library can easily be expanded by the addition of individual new modules. The configuration tool automatically identifies the new module and independently includes it in the configuration process.

The generic software configuration tool is used e.g. for the automatic generation of VHDL files for a processor platform of an ASIC. The processor platform provides the general computing capacity for the ASIC. This amounts e.g. to approximately 20% of the functionality of the ASIC. A user can specify an application-specific processor platform to his requirements. The subsequent automatic generation of the processor platform saves the user considerable time and substantially reduces development costs. In a preferred embodiment of the invention special configurations specified by the user or already known for example as standard configurations can be stored. These stored configurations can then simply be used unchanged or reused modified by changes to one or more parameters, thus allowing in a simple manner a redesign of a processor platform.

Advantageous embodiments are taken from the dependent claims and the description which follows.

### BRIEF DESCRIPTION OF THE DRAWINGS

The invention is now explained with reference to an embodiment example and with the aid of figures. These show:

FIG. 1 a diagrammatic extract of an integrated circuit according to the invention,

FIG. 2 a diagrammatic process of VHDL file generation using this configuration tool according to the invention;

FIG. 3 an example of a selection of parameters via a GUI,

FIG. 4 a second example of a selection of parameters via a GUI,

FIG. 5 a third example of a selection of parameters via a GUI,

FIG. 6 a fourth example of a selection of parameters via a GUI.

### BEST MODE FOR CARRYING OUT THE INVENTION

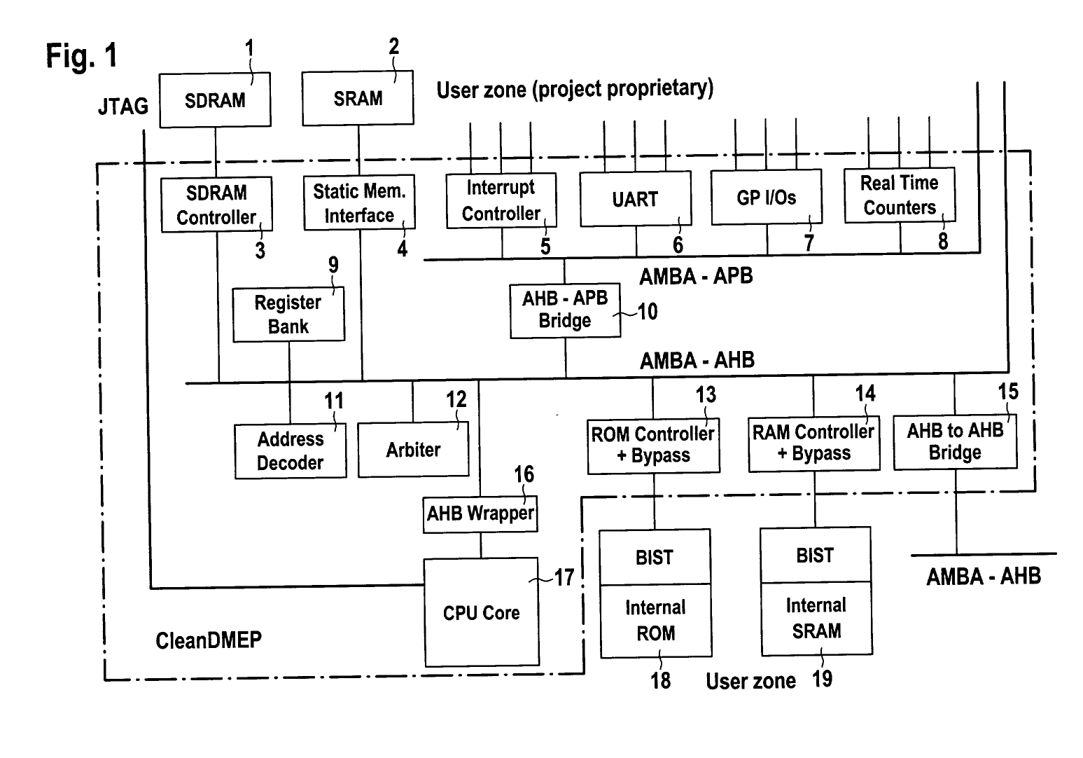

FIG. 1 shows a schematically represented extract of an integrated circuit according to the invention.

This extract has a processor platform marked CleanDMEP and several modules connected with the processor platform; CleanDMEP=clean design methodology for embedded processors. The processor platform is a general platform and can be used for any processing e.g. in telecommunications, machine construction, in the aeronautic and aerospace industry etc; in telecommunications for example in all forms of XDSL, in UMTS, VoIP etc.

The integrated circuit is produced for example as an ASIC or system-on-chip. It contains firstly the special processor platform with a processor 17, three AHB master and/or slave modules 3, 13, 14 and a central register bank 9 which are connected together via a bus AMBA-AHB. Module 3 is designed for example as an SDRAM controller, module 13 as a ROM controller and module 14 as a RAM controller. The register bank 9 contains the three control registers for the three modules 3, 13, 14. Each module 3, 13, 14 has access via the AMBA-AHB bus to the register allocated to it. The bus is for example designed as a fast bus e.g. an AMBA-AHB bus.

The general structure of the processor platform is explained below.

The processor platform contains a module 3 designed as an SDRAM controller which is on the one hand connected with the fast internal AMBA-AHB bus and on the other hand with an internal SDRAM 1 arranged outside the processor platform. Internal means within the integrated circuit, external outside the integrated circuit. The SDRAM controller controls access to the SDRAM 1 and carries out the necessary conversion to bus protocol. The SDRAM 1 can also be arranged outside the integrated circuit i.e. externally.

The processor platform also contains a static memory interface 4 which is on the on hand connected with the fast internal bus AMBA-AHB and on the other hand with an internal SRAM 2 arranged outside the processor platform. The static memory interface 4 controls access to the SRAM 2 and carries out the necessary conversion to the bus protocol. The SRAM 2 can also be arranged outside the integrated circuit i.e. externally.

An interrupt controller 5 is also provided which is on the one hand connected with a slow internal bus e.g. as an AMBA-APB bus and on the other hand with at least one interface to an internal or external module arranged outside the processor platform. The interrupt controller 5 serves to connect interrupts from modules outside the platform with the processor.

A UART 6 is also provided which is on the one hand connected with the slow internal AMBA-APB bus and on the other hand has an interface to an external host processor which is however arranged outside the processor platform. The UART 6 is used to transfer data between the external host processor and the internal processor (17).

A GP I/O 7 is also provided which is on the one hand connected with the slow internal AMBA-APB bus and on the other hand has at least one interface to an internal or external module arranged however outside the processor platform. The GP I/O 7 serves to transfer control information between the modules outside the platform and the internal processor (17); GP I/O=general purpose in/out.

A real time counter 8 is also provided which is on the one hand connected with the slow internal AMBA-APB bus and on the other hand has at least one interface to an internal or external module arranged however outside the processor platform. The real time counter 8 serves as a timer which runs with the system clock.

A register bank 9 is also provided which is connected with the fast AMBA-AHB bus. The register bank 9 provides registers for several modules including e.g. RAM controller 14 and SDRAM controller 3.

An arbiter 12 connected with the fast AMBA-AHB bus serves to prioritise access in the case of simultaneous access of several masters to the fast bus, and to process these in the prioritised sequence.

The processor 17 is for example produced as a microprocessor or digital signal processor. It may be connected with the fast AMBA-AHB bus via an AHB wrapper. The AHB wrapper 16 if necessary performs the required protocol conversion.

The module 13 is designed e.g. as a ROM controller which is on the one hand connected with the fast AMBA-AHB bus and on the other hand with an internal ROM 18 arranged outside the processor platform which may also contain a BIST; BIST=built-in self test.

The ROM controller controls access to the internal ROM 18 and performs the necessary conversion to bus protocol.

The module 14 produced as a RAM controller is on the one hand connected with a fast internal AMBA-AHB bus and on the other hand with an internal SRAM 19 arranged however outside the processor platform. The RAM controller controls access to the SRAM 19 and performs the necessary conversion to bus protocol. The SRAM 19 may also contain a BIST.

A bridge 10 is also provided. Bridge 10 connects the fast AMBA-AHB bus with the slow AMBA-APB bus. Via bridge 10 a connection is thus produced between the modules connected to the AMBA-AHB bus and the modules connected to the AMBA-APB bus. Thus processor 17 via bridge 10 has access e.g. to the interrupt controller 5. The division into two buses with different processing speeds brings the advantage that slow access does not hinder fast access. Bridge 10, AMBA-APB bus and the modules connected to this are optional. If the functionality of the modules is not required, they and the AMBA-APB bus and bridge 10 may be omitted from the design, which leads to space saving and a reduction in production costs.

The processor 17 has a connection to a JTAG=joint test action group. The JTAG interface can be used for debugging the SW on the internal processor but also during production control of the ASIC.

The AMBA-APB bus can be continued internally outside the processor platform and if necessary also externally outside the integrated circuit.

The AMBA-AHB bus can be continued internally outside the processor platform and if necessary also externally outside the integrated circuit.

The embodiment example shows a special processor platform. The invention can be used on any processor platform, in particular a processor platform with less than or more elements than shown in the figure. The integrated circuit can also have more than one processor, more than one control input and more than one external memory. If for example two processors are managed via a common address administration, one control input and one external memory may be sufficient for both processors. Apart from the special processor platform, further processors and modules can be arranged on the integrated circuit and can even represent the majority of the integrated circuit e.g. 80%, so that e.g. only 20% is used for the processor platform. The integrated circuit may also contain two or more processor platforms.

In the embodiment example the modules are produced as ROM, RAM and SDRAM controllers. A module can for example also be produced as a DRAM, PROM, EPROM or EEPROM; PROM=programmable ROM, EPROM=erasable PROM.

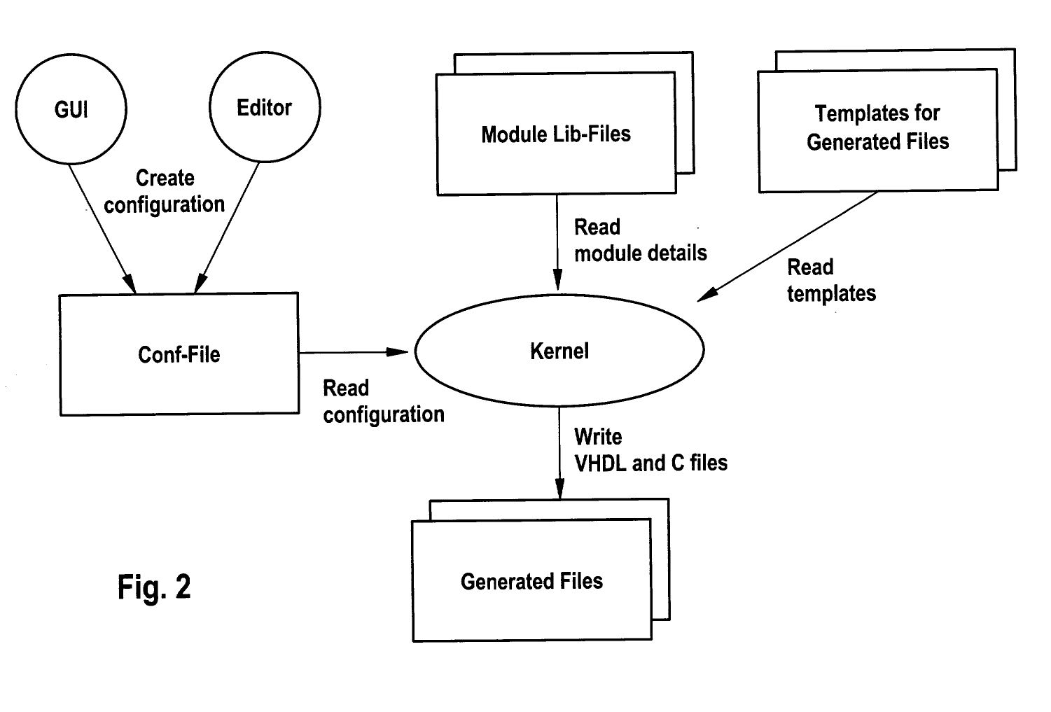

FIG. 2 shows a schematically represented process of VHDL file generation using the configuration tool according to the invention. The VHDL files are used e.g. to produce a processor platform as shown in FIG. 1.

A processor kernel of a computer e.g. a UNIX machine executes the configuration tool which requires three components to generate the VHDL files: a configuration file Conf-File produced by the user for example using the GUI, the module library files Module Lib-Files, and the template files Templates for Generated Files.

The configuration file contains selectable parameters which can be selected e.g. via a GUI or an editor. When all required parameters have been selected, the user can click on Icon Check Constraints (see FIG. 2) whereupon the configuration tool checks whether the selected parameters give a sensible overall configuration or e.g. physical or other impossibilities prevent implementation of the selection. By clicking on an icon Generate all Files (see FIG. 2), generation of the generated files: VHDL files, boot files and test files, can be started. The processor kernel then reads the selected configuration from the configuration file and links this with the module-specific module details read from the Module Library Files and the templates read from the Template Files. This linking generates the VHDL files. The Template Files contain not only configuration-independent program steps but also key words which are replaced with the selected parameters by the Details module. By means of the VHDL files a chip manufacturer then produces the integrated circuit containing the selected processor platform. The selected processor platform is e.g. an RISC processor platform.

The configuration tool generates e.g. software and hardware files including e.g. VHDL top level files, module-specific VHDL files, packages, C-code files and header files. The VHDL top level files contain the wiring of all modules and the packages contain constant definitions. The C-code and header files define the constants and data structures for the software.

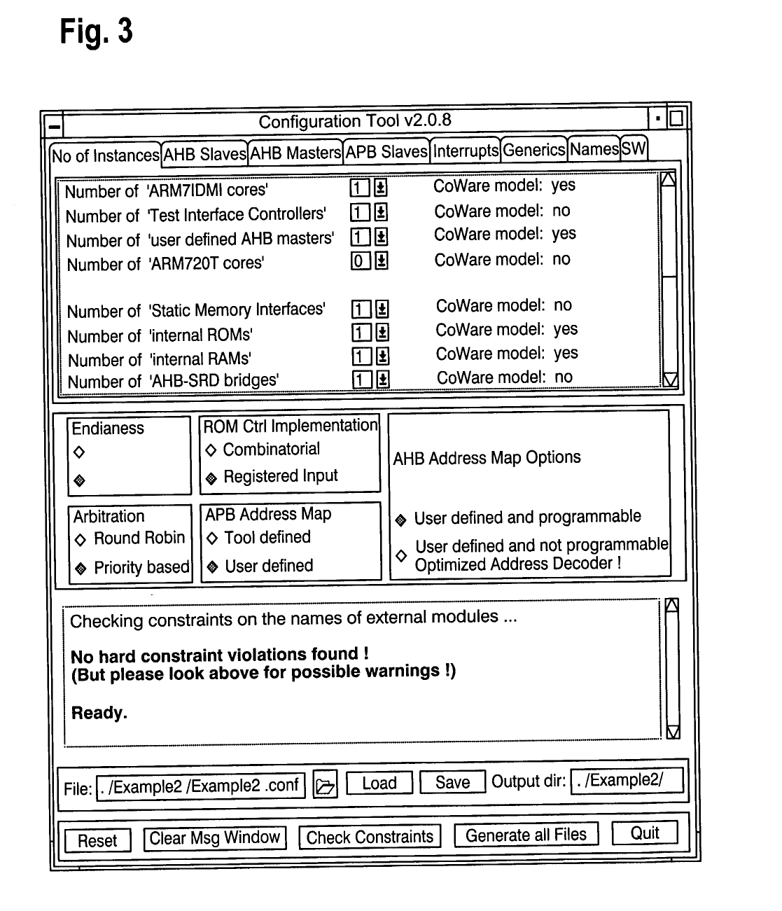

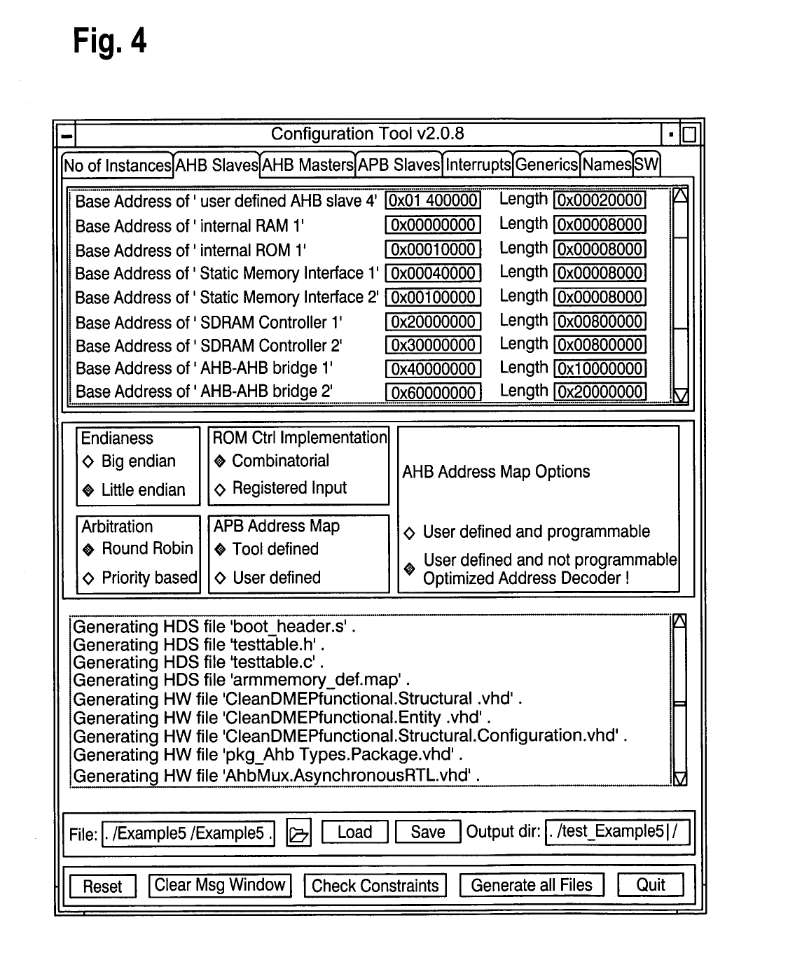

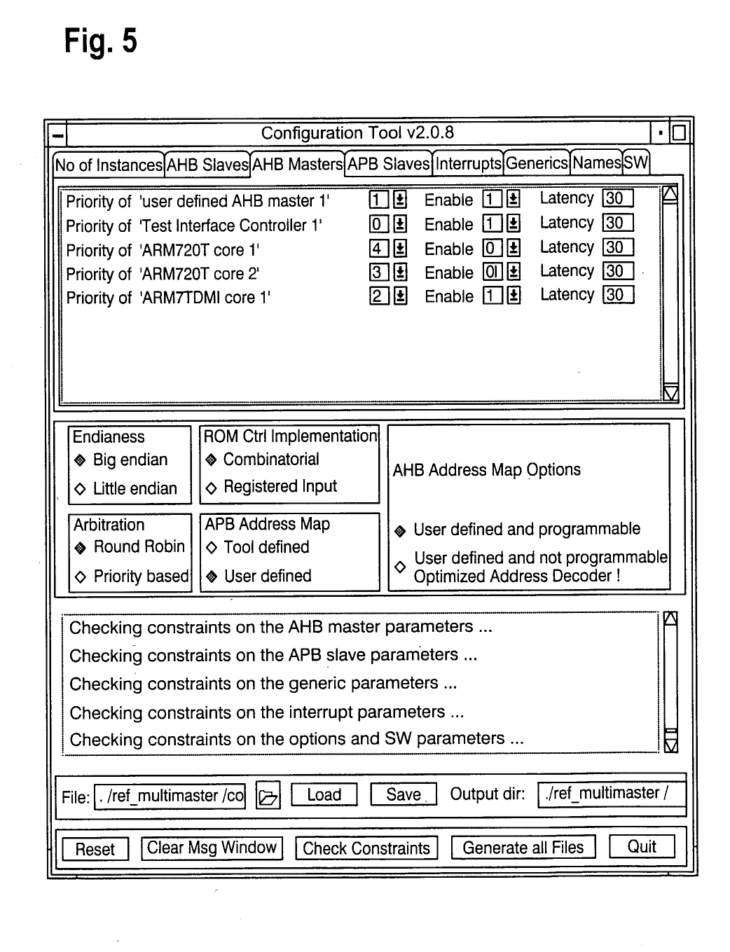

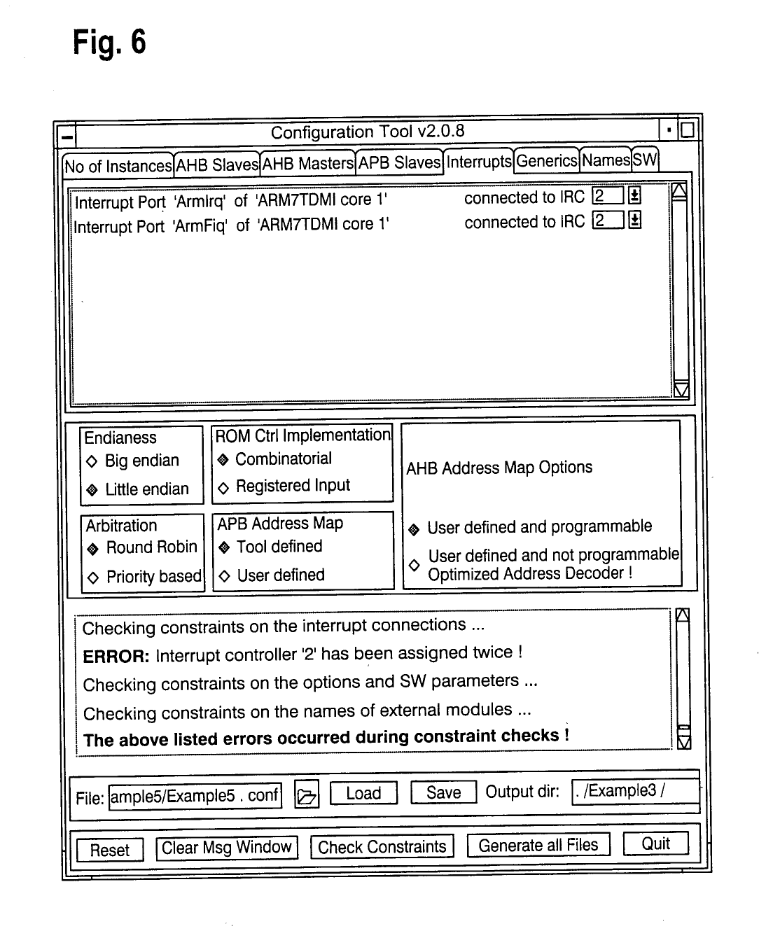

FIGS. 3 to 6 show examples of a selection of parameters via a GUI.

Parameters are for example the number and type of processors e.g. various ARM processors, number of test interface controllers, number of user-defined AHB buses, number of static memory interfaces, number of internal ROMs, number of internal RAMs, number of AHB-APB bridges.

In addition the following for example are also provided as parameters:

type of arbitration: round-robin or priority-based,

type of ROM control implementation: combinatorial or registered input,

type of address map: tool-defined or user-defined,

the address ranges of the modules,

the priorities and initial activation of the processors,

the linking of interrupt controllers to processors,

the definition of module-specific generics,

register addresses of the modules connected with AMBA-APB bus if present,

selection of memory containing the boot software and the fall-back memory.

In the embodiment example, chip-internal AMBA buses are used and chip-external AMBA buses and/or a PCI bus. Chip-internal buses for example can be: CoreConnect Bus, CoreFrame Bus, FISPbus or IPbus. Chip-external buses for example can be: VMEbus, USB bus etc. Instead of one or two buses for chip-internal connection of the modules, three or more buses can be used e.g. an extra bus for linking the arbiter with several modules.

Abbreviations:

AMBA=Advanced micro-controller bus architecture,

AHB=Advanced high performance bus,

APB=Advanced peripheral bus,

ARM=Advanced RISC machine,

VHDL=VHSIC hardware description language.

1. Configuration tool for automatic generation of at least one software file and/or at least one hardware file for a special processor platform for an integrated circuit, in particular an ASIC or a system-on-chip, wherein the processor platform contains at least one processor and at least one module, which are connected together via a bus, wherein the tool contains at least one selectable parameter for at least one processor and at least one module, and wherein the at least one software file and/or at least one hardware file are generated as a function of the parameters selected.

2. Configuration tool according to claim 1, wherein the tool is suitable for generating VHDL files for the special processor platform from the parameters, module library files and template files.

3. Configuration tool according to claim 2, wherein the tool is suitable for generating VHDL files by selection of the modules with the selected parameters from the module library and insertion of the selected modules in predefined places in the templates.

4. Configuration tool according to claim 3, wherein the tool is suitable for generating the software boot files which belong to the generated VHDL files and serve for booting the at least one processor.

5. Configuration tool according to claim 1, wherein a selectable parameter allows a selection of the number of processors, a selection of processor types and/or a selection of the requirement for memory controllers.

6. Computer containing a configuration tool for automatic generation of at least one software file and/or at least one hardware file for a special processor platform for an integrated circuit, in particular an ASIC or a system-on-chip, wherein the processor platform contains at least one processor and at least one module, which are connected together via a bus, wherein the tool contains at least one selectable parameter for at least one processor and at least one module, and wherein the at least one software file and/or at least one hardware file are generated as a function of the parameters selected.

7. Computer according to claim 6, wherein a GUI is present to show the at least one selectable parameter.

8. Memory medium with stored configuration tool for automatic generation of at least one software file and/or at least one hardware file for a special processor platform for an integrated circuit, in particular an ASIC or a system-on-chip, wherein the processor platform contains at least one processor and at least one module, which are connected together via a bus, wherein the tool contains at least one selectable parameter for at least one processor and at least one module, and wherein the at least one software file and/or at least one hardware file are generated as a function of the parameters selected.

9. GUI to provide an interface to a configuration tool for automatic generation of at least one software file and/or at least one hardware file for a special processor platform for an integrated circuit, in particular an ASIC or system-on-chip, wherein the GUI contains at least one icon for selection of at least one parameter for at least one processor and at least one module.
